(19) United States
(12) Patent Application Publication
(10) Pub. No.: US 2010/0306984 A1
(43) Pub. Date: Dec. 9, 2010

(54) Towel system, assembly, and method

(76) Inventors: Joseph Fiore, Bensenville, IL (US); Joseph Fiore, Bensenville, IL (US)

Correspondence Address: Charles F. Meroni, Jr.;Meroni & Meroni, P.C., P.O. Box 309, Barrington, IL, 60011, US

(21) Appl. No.: 12/653,566

(22) Filed: Dec. 16, 2009

Related U.S. Application Data
(63) Continuation-in-part of application No. 12/459,785, filed on Jul. 8, 2009, now abandoned.
Application No. 12/459,785 is a continuation-in-part of application No. 12/455,696, filed on Jun. 5, 2009, now abandoned.

(51) Int. Cl. B32B 3/06; A44B 18/00; A44B 99/00; A44B 17/00; B21D 39/03

(52) U.S. Cl. 29/428; 428/99; 24/450; 24/303; 24/680

(57) ABSTRACT

A towel system, assembly, and method enable a user to quickly identify, retrieve, and replace a moisture-absorbent medium. The towel system comprises, in combination, a circular towel, a support structure, and certain fastening structure. The towel is constructed from a moisture-absorbent medium and comprises a circular periphery, an anterior surface, and a posterior surface. The support structure comprises a vertical support surface. The fastening structure has a fastened thickness and is cooperable with the towel and the support surface for enabling a user to removably fasten the towel to the support surface. The fastening structure comprises towel-based and support-based structures. The fastening structure enables the user to removably fasten the towel adjacent the support surface a distance substantially equal to the fastened thickness for preventing contact between the towel and support surface and enabling the towel to hang within an air space surrounding the anterior and posterior surfaces.

### PRIOR HISTORY

This application claims the benefit of pending U.S. patent application Ser. No. 12/459,785 filed in the United States Patent and Trademark Office on Jul. 8, 2009.

### BACKGROUND OF THE INVENTION

1. Field of the Invention

The present invention relates to the field of towels, and more particularly to a towel construction or assembly intended to for use in settings prone to towel usage, which assembly is quickly identifiable and easily accessible by virtue of the towel construction.

2. Description of the Prior Art

The present invention is primarily intended to be used within settings in which towels are likely to be used, namely kitchen and bathroom type settings. The prior art does not appear to show or describe a low cost, circular towel, specifically outfitted with certain fastening means for removably retaining said towel adjacent a vertical support surface so as to enable the user to quickly identify, retrieve, and replace a moisture-absorbent medium. The prior art thus perceives a need for such an assembly, as remedied by the present invention and described in more detail hereafter.

### SUMMARY OF THE INVENTION

To achieve these and other readily apparent objectives, the present invention essentially provides a towel assembly for enabling a user to quickly identify, retrieve, and replace a moisture-absorbent medium, which towel assembly essentially comprises a circular towel and certain fastening means. The circular towel is preferably constructed from a moisture-absorbent material and comprises a circular periphery, an anterior surface, and a posterior surface. The fastening means may comprise a certain fastened thickness and are cooperable with the circular towel and a vertical support surface for enabling a user to removably fasten the circular towel to the vertical support surface.

The fastening means preferably comprised certain towel-based structure and certain support-based structure wherein the support-based structure is outfitted upon the vertical support surface 16 and the towel-based structure is outfitted upon or into the circular towel radially inwardly adjacent the circular periphery at the posterior surface. The fastening means thereby enable the user to removably fasten the circular towel adjacent the vertical support surface a distance substantially equal to the fastened thickness for preventing contact between the circular towel and vertical support surface and enabling the circular towel to hang within an air space surrounding the anterior and posterior surfaces.

It is further contemplated that these specifications further support certain towel-hanging methodology for enabling a user to quickly identify, retrieve, and replace a moisture-absorbent medium. In this regard, the towel hanging method may be said to comprise a series of steps, including providing a circular towel and certain fastening means as hereinafter more fully described. Certain support-based structure of the fastening means may be outfitted upon the vertical support surface and certain towel-based structure may be outfitted upon the circular towel radially inwardly adjacent the circular periphery at the posterior surface.

The circular towel may then be removably fastened adjacent the vertical support surface a distance substantially equal to the fastened thickness for preventing contact between the circular towel and the vertical support surface after which the circular towel may be hung within the air space surrounding the anterior and posterior surfaces. The towel hanging method may further comprise the steps of: providing the anterior surface with certain first coloration, and the vertical support surface may be provided with certain second coloration; and differing the first and second coloration(s) for enhancing the user's ability to visually identify the circular towel adjacent the vertical support surface.

Other objects of the present invention, as well as particular features, elements, and advantages thereof, will be elucidated in, or apparent from, the following description and the accompanying drawing figures.

### BRIEF DESCRIPTION OF THE DRAWINGS

FIG. 1 is a plan view of a first towel assembly according to the present invention showing a first or anterior towel side thereof, the towel periphery being circular in shape.

FIG. 2 is a side view depiction of a the first towel assembly according to the present invention showing the towel assembly attached via first fastening means to a fragmentary support structure as depicted in broken lines.

FIG. 2(a) is an enlarged sectional view as sectioned from FIG. 2 showing the first fastening means in greater detail.

FIG. 3 is a fragmentary side view depiction of a second towel assembly according to the present invention showing the towel assembly attached via second fastening means to a fragmentary support structure as depicted in broken lines.

FIG. 3(a) is an enlarged sectional view as sectioned from FIG. 3 showing the second fastening means in greater detail.

FIG. 4 is a fragmentary side view depiction of a third towel assembly according to the present invention showing the towel assembly attached via third fastening means to a fragmentary support structure as depicted in broken lines.

FIG. 4(a) is an enlarged sectional view as sectioned from FIG. 4 showing the third fastening means in greater detail.

FIG. 5 is a fragmentary side view depiction of a fourth towel assembly according to the present invention showing the towel assembly attached via fourth fastening means to a fragmentary support structure as depicted in broken lines.

FIG. 5(a) is an enlarged sectional view as sectioned from FIG. 5 showing the fourth fastening means in greater detail.

### DETAILED DESCRIPTION OF THE PREFERRED EMBODIMENT

Referring now to the drawings with more specificity, the present invention provides a towel system, assembly, and method for enabling a user to quickly identify, retrieve, and replace a moisture-absorbent medium. In this regard, it is contemplated that the towel system according to the present invention comprises, in combination a circular towel 10; a support structure 11 with vertical support surface 16; and certain fastening means. The circular towel 10 is preferably constructed from a moisture-absorbent medium and comprises a circular periphery 13, an anterior surface 14, and a posterior surface 15.

The fastening means preferably comprise a certain fastened thickness as at 100 and are cooperable with the circular towel 10 and the vertical support surface 16 for enabling a user to removably fasten the circular towel 10 to the vertical support surface 16. The fastening means preferably comprise certain towel-based structure and certain support-based structure. The support-based structure is outfitted upon the vertical support surface 16 and the towel-based structure is outfitted upon or into the circular towel 10 radially inwardly adjacent the circular periphery 13 at the posterior surface 15.

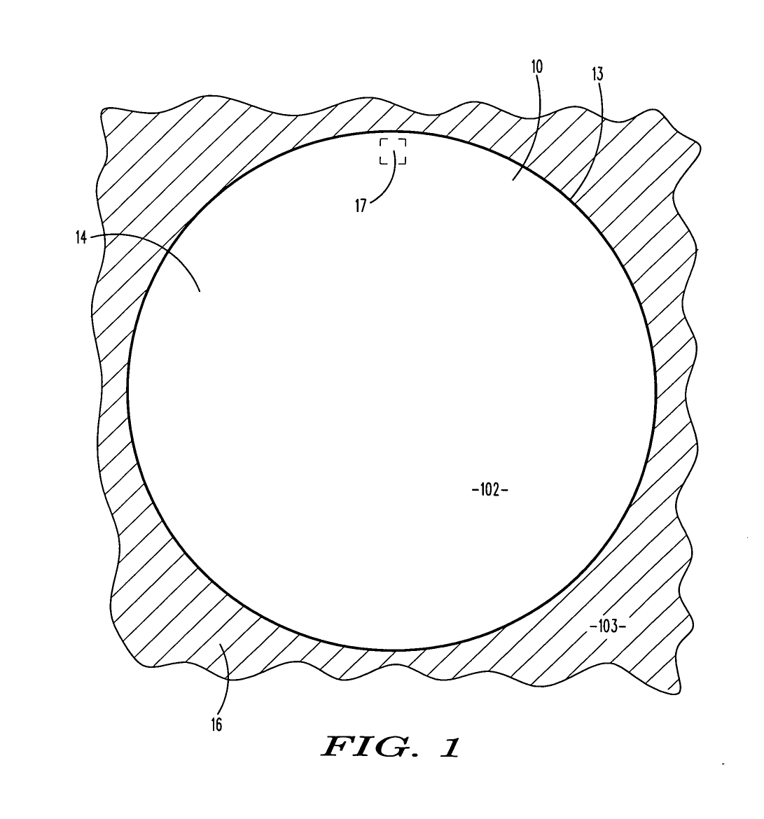

The fastening means thereby enable the user to removably fasten the circular towel 10 adjacent the vertical support surface 16 a distance substantially equal to the fastened thickness 100 for preventing contact between the circular towel 10 and the vertical support surface 16 thereby further enabling the circular towel 10 to hang within an air space 101 surrounding the anterior and posterior surfaces 14 and 15. The anterior surface 14 and the vertical support surface 16 may preferably comprise differing coloration as generally depicted in FIG. 1 for enhancing the user's ability to visually identify the circular towel 10 adjacent the vertical support surface 16.

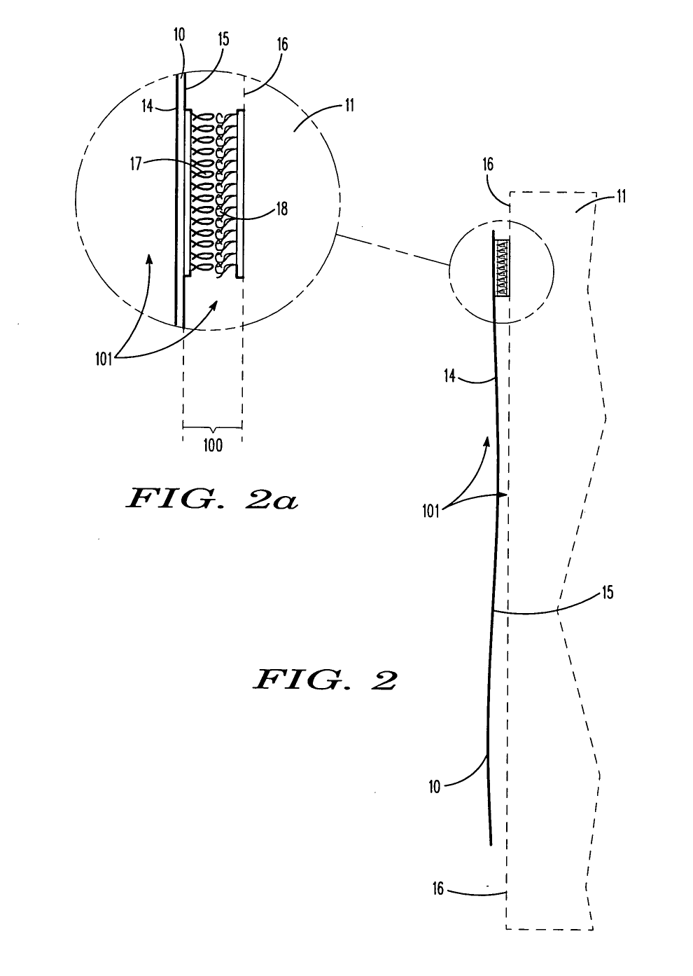

It is contemplated that the fastening means may be preferably defined by cooperable hook and loop type fastening structure such as VELCRO brand hook and loop fastening structure as generally depicted in FIGS. 2 and 2(a). The towel-based structure of the fastening means may be preferably defined by loop type structure 17 as generally depicted in FIGS. 1, 2(a), and 4(a); and the support-based structure of the fastening means may be defined by hook type structure 18 as generally depicted in FIGS. 2(a) and 4(a). Notably, from a comparative inspection of FIGS. 4 and 4(a), the loop type structure 17 may be further defined by a hook-receiving aperture 19 extending from the anterior surface 14 to the posterior surface 15 and formed in the circular towel 10 radially inwardly adjacent the circular periphery 13.

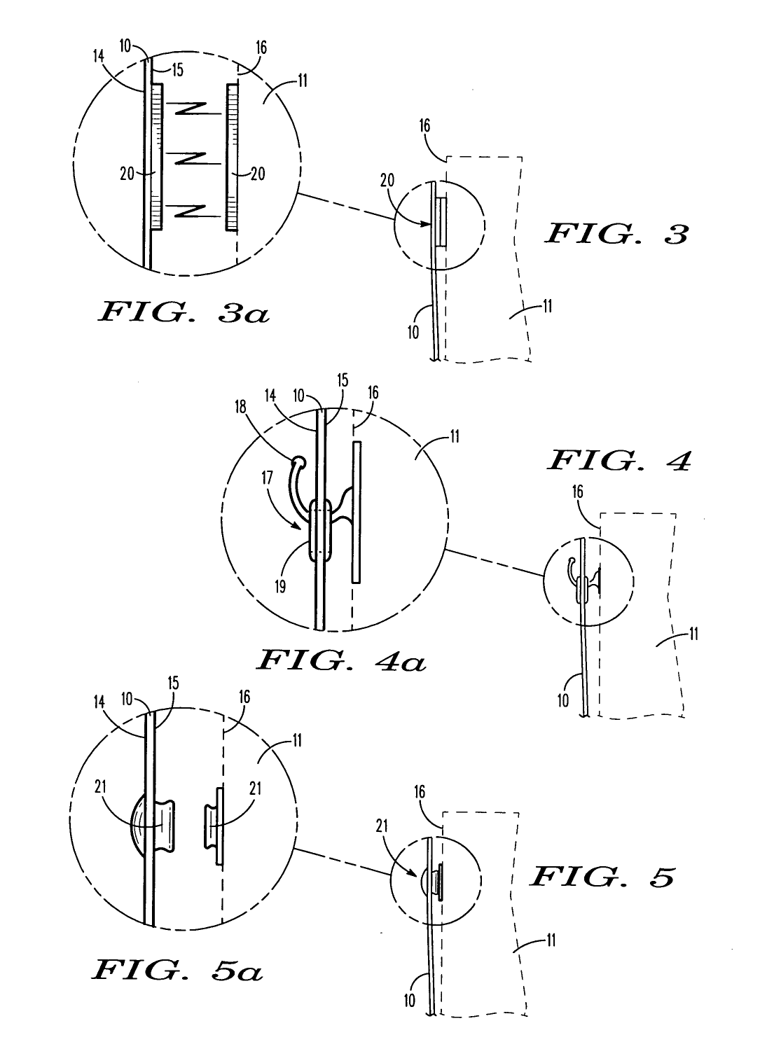

It is further contemplated, however, that the fastening means may be defined by any number of cooperable fastening means that are outfittable upon or in the circular towel 10 and outfittable upon the vertical support surface 16 such that the circular towel 10 hangs within the air space 101 surrounding the anterior and posterior surfaces 14 and 15. For example, it is contemplated that the fastening means may be defined by certain magnetic means for fastened attachment 20 as generally depicted in FIGS. 3 and 3(a), or may be defined by certain snap type means for fastened attachment 21 as generally depicted in FIGS. 5 and 5(a).

While the foregoing descriptions have been set forth with a great deal of specificity, the descriptions of the present invention have been made with respect to specific arrangements and constructions of a towel system. It will be apparent to those skilled in the art that the foregoing description is for illustrative purposes only, and that various changes and modifications can be made to the present invention without departing from the overall spirit and scope of the present invention.

For example, the essence of the invention may be said to provide a towel assembly towel assembly for enabling a user to quickly identify, retrieve, and replace a moisture-absorbent medium, which towel assembly essentially comprises a circular towel 10 and certain fastening means. The circular towel 10 is preferably constructed from a moisture-absorbent material and comprises a circular periphery 13, an anterior surface 14, and a posterior surface 15. The fastening means preferably comprise a certain fastened thickness as at 100 and are cooperable with the circular towel 10 and a vertical support surface (as at 16) for enabling a user to removably fasten the circular towel 10 to the vertical support surface 16.

The fastening means preferably comprised certain towel-based structure and certain support-based structure wherein the support-based structure is outfitted upon the vertical support surface 16 and the towel-based structure is outfitted upon or into the circular towel 10 radially inwardly adjacent the circular periphery 13 at the posterior surface 15. The fastening means thereby enable the user to removably fasten the circular towel 10 adjacent the vertical support surface 16 a distance substantially equal to the fastened thickness 100 for preventing contact between the circular towel 10 and vertical support surface 16 and enabling the circular towel 10 to hang within an air space 101 surrounding the anterior and posterior surfaces 14 and 15.

It is further contemplated that the foregoing specifications further support certain towel-hanging methodology for enabling a user to quickly identify, retrieve, and replace a moisture-absorbent medium. In this regard, the towel hanging method may be said to comprise a series of steps, including providing a circular towel 10 and certain fastening means as heretofore described. The support based structure of the fastening means may be outfitted upon the vertical support surface 16 and the towel-based structure may be outfitted upon the circular towel 10 radially inwardly adjacent the circular periphery 13 at the posterior surface 15.

The circular towel 10 may then be removably fastened adjacent the vertical support surface 16 a distance substantially equal to the fastened thickness 100 for preventing contact between the circular towel 10 and the vertical support surface 16 after which the circular towel may be hung within the air space 101 surrounding the anterior and posterior surfaces 14 and 15. The towel hanging method may further comprise the steps of: providing the anterior surface with certain first coloration (e.g. white 102), and the vertical support surface 16 may be provided with certain second coloration (e.g. generic non-white coloration 103) as generally depicted in FIG. 1; and differing the first and second coloration(s) 102 and 103 for enhancing the user's ability to visually identify the circular towel 10 adjacent the vertical support surface 16.

Accordingly, although the invention has been described by reference to certain alternative embodiments of the towel assembly and a towel hanging method, it is not intended that the novel towel assembly or method be limited thereby, but that modifications thereof are intended to be included as falling within the broad scope and spirit of the foregoing disclosure, the following claims and the appended drawings.

We claim:

1. A towel system for enabling a user to quickly identify, retrieve, and replace a moisture-absorbent medium, the towel system comprising, in combination:
a circular towel, the circular towel being constructed from a moisture-absorbent medium and comprising a circular periphery, an anterior surface, and a posterior surface;
a support structure, the support structure comprising a vertical support surface; and
fastening means, the fastening means having a fastened thickness and being cooperable with the circular towel and the vertical support surface for enabling a user to removably fasten the circular towel to the vertical support surface, said fastening means comprising towel-based structure and support-based structure, the support-based structure being outfitted upon the vertical support surface, the towel-based structure being outfitted upon or into the circular towel radially inwardly adjacent the circular periphery at the posterior surface, the fastening means thereby enabling the user to removably fasten the circular towel adjacent the vertical support surface a distance substantially equal to the fastened thickness for preventing contact between the circular towel and vertical support surface and enabling the circular towel to hang within an air space surrounding the anterior and posterior surfaces.

2. The towel system of claim 1 wherein the anterior surface and the vertical support surface comprise differing coloration, the differing coloration for enhancing the user's ability to visually identify the circular towel adjacent the vertical support surface.

3. The towel system of claim 1 wherein the fastening means are defined by cooperable hook and loop type fastening structure.

4. The towel system of claim 3 wherein the towel-based structure is defined by loop type structure and the support-based structure is defined by hook type structure, the loop type structure being defined by a hook-receiving aperture formed in the circular towel radially inwardly adjacent the circular periphery.

5. The towel system of claim 1 wherein the fastening means are defined by cooperable magnetic means for fastened attachment.

6. The towel system of claim 1 wherein the fastening means are defined by cooperable snap type means for fastened attachment.

7. A towel assembly for enabling a user to quickly identify, retrieve, and replace a moisture-absorbent medium, the towel assembly comprising:
a circular towel, the circular towel being constructed from a moisture-absorbent material and comprising a circular periphery, an anterior surface, and a posterior surface; and
fastening means, the fastening means having a fastened thickness and being cooperable with the circular towel and a vertical support surface for enabling a user to removably fasten the circular towel to the vertical support surface, said fastening means comprising towel-based structure and support-based structure, the support-based structure being outfitted upon the vertical support surface, the towel-based structure being outfitted upon or into the circular towel radially inwardly adjacent the circular periphery at the posterior surface, the fastening means thereby enabling the user to removably fasten the circular towel adjacent the vertical support surface a distance substantially equal to the fastened thickness for preventing contact between the circular towel and vertical support surface and enabling the circular towel to hang within an air space surrounding the anterior and posterior surfaces.

8. The towel system of claim 7 wherein the anterior surface and the vertical support surface comprise differing coloration, the differing coloration for enhancing the user's ability to visually identify the circular towel adjacent the vertical support surface.

9. The towel system of claim 7 wherein the fastening means are defined by cooperable hook and loop type fastening structure.

10. The towel system of claim 9 wherein the towel-based structure is defined by loop type structure and the support-based structure is defined by hook type structure, the loop type structure being defined by a hook-receiving aperture formed in the circular towel radially inwardly adjacent the circular periphery.

11. The towel system of claim 7 wherein the fastening means are defined by cooperable magnetic means for fastened attachment.

12. The towel system of claim 7 wherein the fastening means are defined by cooperable snap type means for fastened attachment.

13. A towel hanging method for enabling a user to quickly identify, retrieve, and replace a moisture-absorbent medium, the towel hanging method comprising the steps of:
providing a circular towel, the circular towel being constructed from a moisture-absorbent material and comprising a circular periphery, an anterior surface, and a posterior surface;
providing fastening means, the fastening means having a fastened thickness and being cooperable with the circular towel and a vertical support surface for enabling a user to removably fasten the circular towel to the vertical support surface, said fastening means comprising towel-based structure and support-based structure;
outfitting the support-based structure upon the vertical support surface;
outfitting the towel-based structure upon or into the circular towel radially inwardly adjacent the circular periphery at the posterior surface;
removably fastening the circular towel adjacent the vertical support surface a distance substantially equal to the fastened thickness for preventing contact between the towel and vertical support surface; and
hanging the circular towel within an air space surrounding the anterior and posterior surfaces.

14. The towel hanging method of claim 13 wherein the anterior surface is provided with first coloration and the vertical support surface is provided with second coloration, the method comprising the step of differing the first and second coloration(s) for enhancing the user's ability to visually identify the circular towel adjacent the vertical support surface.

15. The towel hanging method of claim 14 wherein the fastening means are defined by cooperable hook and loop type fastening structure.

16. The towel hanging method of claim 15 wherein the towel-based structure is defined by loop type structure and the support-based structure is defined by hook type structure, the loop type structure being defined by a hook-receiving aperture formed in the circular towel radially inwardly adjacent the circular periphery.

17. The towel system of claim 14 wherein the fastening means are defined by cooperable magnetic means for fastened attachment.

18. The towel system of claim 14 wherein the fastening means are defined by cooperable snap type means for fastened attachment.
